(19) United States
(12) Patent Application Publication
(10) Pub. No.: US 2020/0342336 A1
(43) Pub. Date: Oct. 29, 2020

(54) VISITING-FACILITY RECOMMENDING DEVICE AND VISITING-FACILITY RECOMMENDING METHOD

(71) Applicant: HONDA MOTOR CO., LTD., MINATO-KU, TOKYO (JP)

(72) Inventors: Yoshiaki SUGIMOTO, MINATO-KU, TOKYO (JP); Tadashi KURIHARA, MINATO-KU, TOKYO (JP); Minoru FUKUMORI, MINATO-KU, TOKYO (JP)

(21) Appl. No.: 16/758,261

(22) PCT Filed: Oct. 19, 2018
(86) PCT No.: PCT/JP2018/039084

§ 371 Date: Apr. 22, 2020

(30) Foreign Application Priority Data
Oct. 26, 2017 (JP) 2017-206985

(51) Int. Cl. G06N 5/04; G01C 21/36; G06Q 50/14; H04W 4/029; H04W 4/024; G08G 1/0968

(52) U.S. Cl. CPC G06N 5/04; G01C 21/3679; G06Q 50/14; H04W 4/029; G08G 1/096894; G08G 1/096827; G08G 1/096855; G08G 1/096883; H04W 4/024

(57) ABSTRACT

The purpose of the present invention is to recommend a facility to visit, without requiring installation of special equipment in facilities. A visiting-facility recommending device is provided with: a communication unit that receives the current positions of a plurality of mobile bodies; a storage unit in which road map information and information about a plurality of facilities are saved; a staying-facility estimating unit that estimates a staying facility at which a target mobile body, which is a mobile body chosen as an estimation target, is staying; a movement-correlation calculating unit that calculates movement correlations among the plurality of facilities from past movement histories of the plurality of mobile bodies among the facilities; and a facility recommending unit that selects a facility recommended to be visited next on the basis of the estimated staying facility and the calculated movement correlations among the facilities.

### TECHNICAL FIELD

The present invention relates to a visiting-facility recommending device and a visiting-facility recommending method that recommend a facility to be visited.

### BACKGROUND ART

In recent years, a technique has been known which acquires the positional information of a mobile body, such as a car, and performs various processes using the acquired positional information. For example, a navigation device has been known which performs route guidance to a destination on the basis of the positional information of a facility designated as the destination by a user and the positional information of a mobile body.

The use of the navigation device enables the user to smoothly move to a museum or an event hall which is a destination even in an area other than the living area which is away from home. However, it is necessary for the user to designate a destination in order for the navigation device to perform route guidance. Therefore, in a case in which the user does not know the facility to go to after visiting the destination, the user wastes time by searching for the facility to be visited at that place or goes home to miss the opportunity to visit another facility.

For example, Patent Document 1 discloses a technique which recommends a facility to be visited next to a user in order to prevent this situation. The technique disclosed in Patent Document 1 allows the user to select the facility recommended to be visited next according to the degree of use (degree of congestion) of each facility. Then, the selected recommended facility is recommended to the user. Therefore, the user can visit a facility with a low degree of use (that is, a facility that is not crowded).

Patent Document 1: Japanese Unexamined Patent Application, Publication No. 2016-157372

### DISCLOSURE OF THE INVENTION

### Problems to be Solved by the Invention

In order to use the technique disclosed in Patent Document 1, a surveillance camera for acquiring a scene image needs to be installed in each facility to check the degree of use in each facility. Further, it is necessary to analyze the scene image acquired by each camera, to analyze the analysis result, and to calculate the degree of use of each facility. However, it is not easy to install the surveillance camera in each facility only for the recommendation of facilities and to share the analysis results of the scene images. In particular, in a case in which the operators of the facilities are different from each other, it is difficult to uniformly install the surveillance cameras in all the facilities.

The invention has been made in view of the above-mentioned problems and an object of the invention is to provide a visiting-facility recommending device and a visiting-facility recommending method that can recommend a facility to be visited, without installing dedicated equipment in each facility.

### Means for Solving the Problems

(1) A visiting-facility recommending device (for example, a visiting-facility recommending device 30 which will be described below) according to the invention includes: a receiving unit (for example, a communication unit 33 which will be described below) that receives current positions of a plurality of mobile bodies;

a map unit (for example, a storage unit 32 which will be described below) that stores road map information and information of a plurality of facilities; a staying-facility estimating unit (for example, a staying-facility estimating unit 312 which will be described below) that estimates a staying facility at which a target mobile body which is a mobile body as an estimation target is staying; a movement-correlation calculating unit (for example, a movement-correlation calculating unit 313 which will be described below) that calculates a movement correlation between the facilities from a past movement history of the plurality of mobile bodies between the plurality of facilities; and a facility recommending unit (for example, a facility recommending unit 314 which will be described below) that selects a facility recommended to be visited next on the basis of the estimated staying facility and the calculated movement correlation between the facilities.

According to the visiting-facility recommending device described in (1), a facility to which the user moves from the current facility is recommended on the basis of, for example, the past movement history. Therefore, even in a case in which the user does not make a plan for the facility to visit, it is possible to recommend an appropriate facility. In addition, since a facility is recommended on the basis of, for example, the past movement history, it is not necessary to install dedicated equipment in each facility.

(2) In the visiting-facility recommending device according to (1), the staying-facility estimating unit may estimate a facility at which the target mobile body is currently staying or a facility at which the target mobile body has stayed last as the staying facility on the basis of a current position of the target mobile body.

According to the visiting-facility recommending device described in (2), it is possible to select a facility correlated with the facility at which the target mobile body is currently staying or the facility at which the target mobile body has stayed last as the facility recommended to be visited next. That is, it is possible to recommend, to the user, a facility correlated with the facility at which the user of the target mobile body is actually staying or the facility at which the user of the target mobile body has stayed.

(3) In the visiting-facility recommending device according to (1), the receiving unit may further receive information of a destination of the target mobile body and the staying-facility estimating unit may estimate a facility that is the destination of the target mobile body as the staying facility on the basis of the received information of the destination of the target mobile body.

According to the visiting-facility recommending device described in (3), it is possible to select a facility correlated with the facility that is the destination of the target mobile body as the facility recommended to be visited next. That is, it is possible to recommend, to the user, a facility correlated with the facility to be visited by the user of the target mobile body.

(4) The visiting-facility recommending device according to any one of (1) to (3) may further include a traffic information acquisition unit (for example, a traffic information acquisition unit according to a modification example which will be described below) that acquires current or future traffic information. The facility recommending unit may select the facility recommended to be visited next in consideration of the current or future traffic information.

According to the visiting-facility recommending device described in (4), since traffic information including, for example, a road congestion situation is also considered, it is possible to prevent the visiting facility to which the route is congested from being recommended. In addition, the users who visit again are concentrated. It is possible to prevent the facility from being crowded.

(5) In the visiting-facility recommending device according to any one of (1) to (4), the map unit may further store facility type information in the information of the plurality of facilities and the facility recommending unit may accumulate a history of the staying facility and select the facility recommended to be visited next, further considering type information of the history of the staying facility.

According to the visiting-facility recommending device described in (5), for example, since a category, such as a restaurant facility or a hot spring facility, is considered, it is possible to prevent the device from recommending a restaurant facility to the user who is visiting the restaurant facility again or to prevent the device from recommending a hot spring facility to the user who is visiting the hot spring facility again.

(6) In the visiting-facility recommending device according to any one of (1) to (5), the map unit may further store information of an estimated stay time at a facility in the information of the plurality of facilities and the facility recommending unit may calculate an expected exit time from the facility recommended to be visited next, on the basis of the estimated stay time at the selected facility recommended to be visited next and a movement time between the facilities estimated from the past movement history of the plurality of mobile bodies between the plurality of facilities.

According to the visiting-facility recommending device described in (6), it is possible to perform recommendation, considering information including the exit time from the facility. Therefore, for example, the user can determine whether or not to go when the facility is closed at 17:00.

(7) According to the invention, there is provided a visiting-facility recommending method performed by a computer. The method includes: a receiving step of receiving current positions of a plurality of mobile bodies; a map step of storing road map information and information of a plurality of facilities in a map unit; a staying-facility estimating step of estimating a staying facility at which a target mobile body which is a mobile body as an estimation target is staying; an inter-facility movement correlation calculation step of calculating a movement correlation between the facilities from a past movement history of the plurality of mobile bodies between the plurality of facilities; and a facility recommending step of selecting a facility recommended to be visited next on the basis of the estimated staying facility and the calculated movement correlation between the facilities.

According to the visiting-facility recommending method described in (7), the same effect as that in the visiting-facility recommending device described in (1) is obtained.

### Effects of the Invention

According to the invention, it is possible to recommend a facility to be visited without installing dedicated equipment in each facility.

### BRIEF DESCRIPTION OF THE DRAWINGS

FIG. 1 is a block diagram illustrating the entire basic configuration of a visiting-facility recommending system according to an embodiment of the invention.

FIG. 2 is a functional block diagram illustrating the functional configuration of an in-vehicle navigation device in the embodiment of the invention.

FIG. 3 is a functional block diagram illustrating the functional configuration of a mobile terminal in the embodiment of the invention.

FIG. 4 is a functional block diagram illustrating the functional configuration of a visiting-facility recommending device in the embodiment of the invention.

FIG. 5 is a diagram illustrating an example of a movement history database in the embodiment of the invention.

FIG. 6 is a diagram illustrating an example of facility information in the embodiment of the invention.

FIG. 7 is a flowchart illustrating a basic operation in the embodiment of the invention.

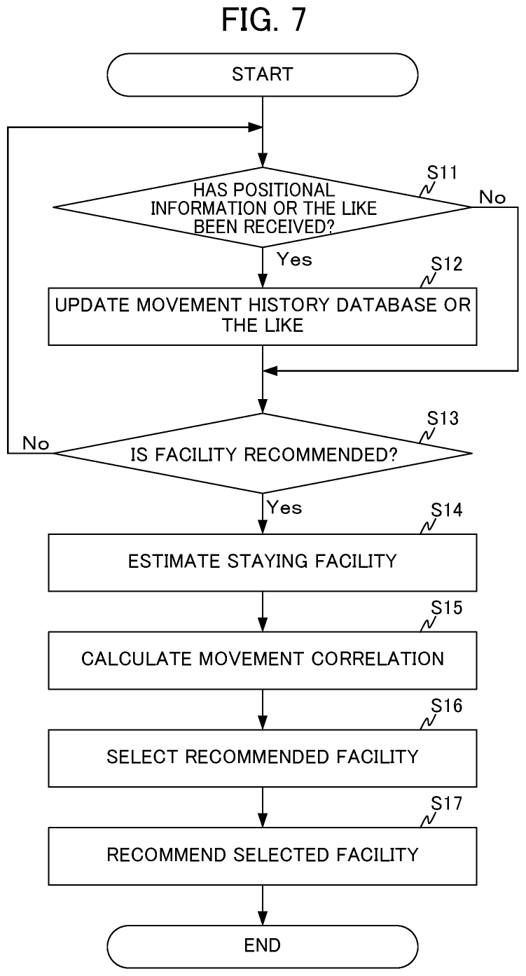

### PREFERRED MODE FOR CARRYING OUT THE INVENTION

Hereinafter, preferred embodiments of the invention will be described in detail with reference to the drawings.

### <Entire Configuration of Visiting-facility Recommending System 1>

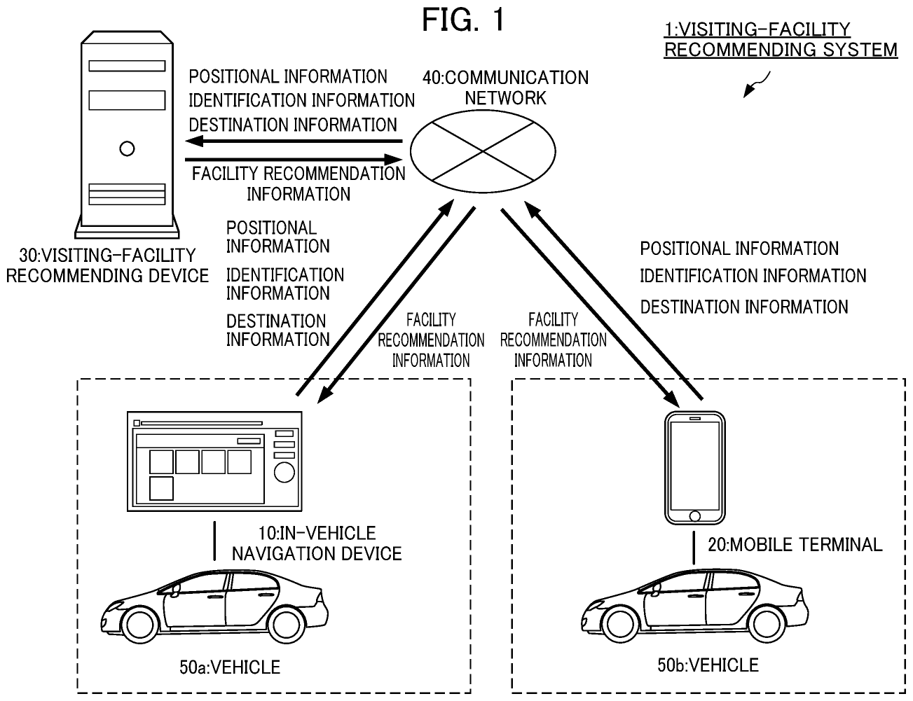

A visiting-facility recommending system 1 according to a preferred embodiment of the present invention will be described. FIG. 1 illustrates the overall configuration of the visiting-facility recommending system 1.

As illustrated in FIG. 1, the visiting-facility recommending system 1 is configured to include an in-vehicle navigation device 10, a mobile terminal 20, and a visiting-facility recommending device 30. Each device and each terminal are connected through a communication network 40 so as to communicate with each other. The drawings illustrate positional information, identification information, destination information, and facility recommendation information which are transmitted and received by each device and each terminal. However, these information items are an example of transmitted and received information. In this embodiment, information other than these information items may be transmitted and received.

The in-vehicle navigation device 10 is a device that performs navigation (route guidance) for a user in a vehicle 50a. The in-vehicle navigation device 10 performs route guidance from the current position to a destination on the basis of a request from the user. The in-vehicle navigation device 10 also has a function of measuring the positional information of the in-vehicle navigation device 10. The positional information measured by the in-vehicle navigation device 10 is appropriately transmitted to the visiting-facility recommending device 30 together with identification information for identifying the in-vehicle navigation device 10 and time information indicating the time when the positional information was measured. Here, since the in-vehicle navigation device 10 and the vehicle 50a are used as a one-to-one pair, the transmitted positional information and identification information can be substantially regarded as the positional information and identification information of the vehicle 50a. The in-vehicle navigation device 10 can be achieved by a car navigation device that is provided in the vehicle 50a which is a mobile body or a portable navigation device (PND) that is portable and is simply provided in the vehicle 50a which is a mobile body.

The mobile terminal 20 is a mobile terminal that is used by the user in the vehicle 50b. The mobile terminal 20 has a function of measuring the positional information of the mobile terminal 20 (that is, the positional information of the vehicle 50b), similarly to the in-vehicle navigation device 10 described above. The positional information measured by the mobile terminal 20 is appropriately transmitted to the visiting-facility recommending device 30 together with identification information for identifying the mobile terminal 20 and time information indicating the time when the positional information was measured, similarly to the positional information measured by the in-vehicle navigation device 10. Here, since the mobile terminal 20 and the vehicle 50a are used as a one-to-one pair, the transmitted positional information and identification information can be substantially regarded as the positional information and identification information of the vehicle 50a. The mobile terminal 20 can be achieved by a smart phone, a mobile phone, a tablet terminal, a notebook computer, and other mobile electronic devices.

In the drawings, a set of the in-vehicle navigation device 10 and the vehicle 50a and a set of the mobile terminal 20 and the vehicle 50b are illustrated. However, the number of sets is not particularly limited. This embodiment may include any number of sets. Further, in the following description, in a case in which the vehicle 50a provided with the in-vehicle navigation device 10 and the vehicle 50b carrying the user of the mobile terminal 20 are not distinguished from each other, the alphabet at the end is omitted and the vehicles are simply referred to as “vehicles 50”.

The visiting-facility recommending device 30 is a device that recommends a facility to be visited and recommends a facility (in some cases, referred to as a point of interest (POI)), such as a commercial facility to be visited, to the user who uses the vehicle 50. Here, the visiting-facility recommending device 30 recommends the facility on the basis of, for example, the positional information of the vehicle 50. Therefore, in this embodiment, it is possible to recommend the facility to be visited, without installing dedicated equipment in each facility. The detailed content of a facility recommending method by the visiting-facility recommending device 30 will be described below. The visiting-facility recommending device 30 can be achieved by, for example, a server device.

The communication network 40 is achieved by a network, such as the Internet or a mobile phone network, or a network obtained by combining them.

The vehicle 50 is a mobile body that carries the user of the in-vehicle navigation device 10 or the mobile terminal 20. The vehicle 50 is achieved by, for example, a four-wheeled vehicle, a motorcycle, or a bicycle.

### <Functional Blocks of In-Vehicle Navigation Device 10>

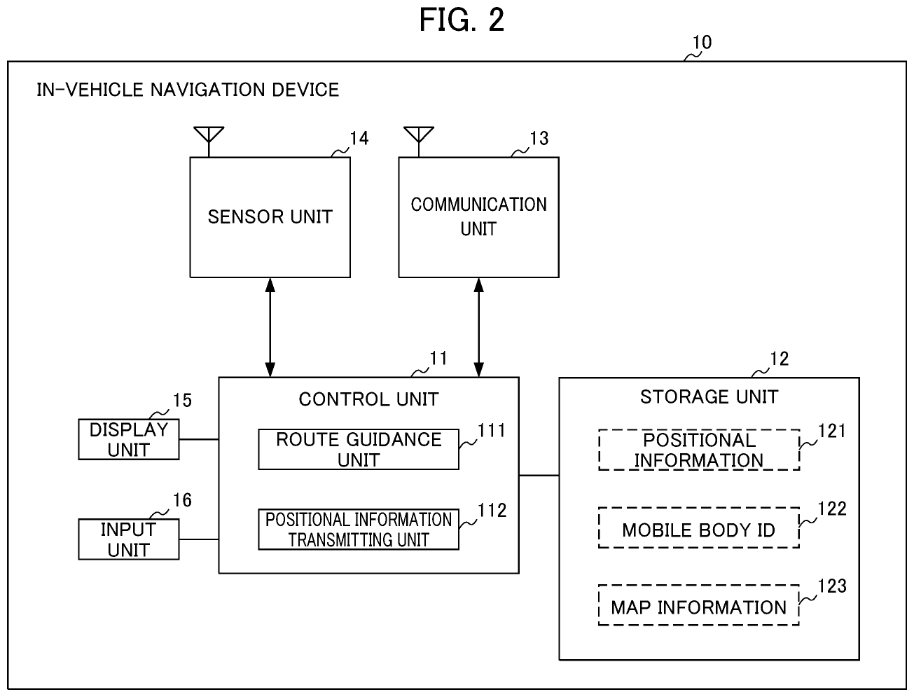

Next, the functional blocks of the in-vehicle navigation device 10 will be described with reference to a block diagram of FIG. 2. Here, the in-vehicle navigation device 10 is supplied with power from the vehicle 50a and is automatically activated by the turn-on of an ignition switch of the vehicle 50a (the startup of the engine) by the user in the vehicle 50a. Then, the in-vehicle navigation device 10 is operated until the user in the vehicle 50a turns off the ignition switch of the vehicle 50a (stops the engine).

As illustrated in FIG. 2, the in-vehicle navigation device 10 is configured to include a control unit 11, a storage unit 12, a communication unit 13, a sensor unit 14, a display unit 15, and an input unit 16.

The control unit 11 is configured by an arithmetic processing device, such as a microprocessor, and controls each unit forming 10. The control unit 11 will be described in detail below.

The storage unit 12 is configured by, for example, a semiconductor memory and stores various programs including a control program which is called firmware or an operating system, a program for performing a route guidance process, and a program for performing a process of transmitting, for example, positional information to the visiting-facility recommending device 30, and various kinds of information including map information. In the drawings, positional information 121, a mobile body ID 122, and map information 123 related to the description of this embodiment are illustrated as the information stored in the storage unit 12.

The positional information 121 is the positional information of the in-vehicle navigation device 10 (that is, the positional information of the vehicle 50a) measured by the sensor unit 14 which will be described below. The positional information 121 is achieved by, for example, latitude and longitude information indicating a position. The positional information 121 includes not only information indicating the measured position but also information indicating the positioning time when the positioning was performed.

The mobile body ID 122 is information for identifying the in-vehicle navigation device 10. For example, a manufacturing number uniquely assigned to the in-vehicle navigation device 10 can be used as the mobile body ID 122. In addition, a telephone number assigned to a subscriber identity module (SIM) which is inserted into the communication unit 13 to connect the communication unit 13 to the communication network 40 which is a network, such as a mobile phone network, can be used as the mobile body ID 122. Further, a vehicle identification number (VIN) or a license plate number that has been uniquely assigned to the vehicle 50a can be used as the mobile body ID 122.

Furthermore, the map information 123 includes information, such as road information, facility position information, and parking lot information as information related to features such as roads and facilities. The map information 123 also includes, for example, display map data for displaying roads and the backgrounds of road maps, the positional information and type information of nodes (for example, intersection points, bends, and end points of roads), the positional information and type information of links which are paths connecting nodes, and road network data including link cost data related to the cost information (for example, the distance and required time) of all links.

So-called road map information, such as a road type and a traffic light, is stored as the road information. The positional information of each facility, such as latitude and longitude information, is stored as the facility position information. In addition, the facility position information may include accessory information, such as the identification information (facility ID), name, type (and/or genre), phone number, address, and business hours of a facility, a menu provided when the facility is a restaurant, and facility information related to product services.

The positional information of a parking lot is stored as the parking lot information. Similarly to the positional information 121, the positional information of the parking lot is achieved by, for example, latitude and longitude information indicating a position. In a case in which the parking lot is a parking lot of each facility, the facilities and the parking lots are stored so as to be associated with each other. In addition, information, such as the available parking time of the parking lot, the number of available parking spaces, or the size of the vehicle 50 that can be parked, is stored as the parking lot information.

The map information 123 may be stored in advance in the storage unit 32 when the in-vehicle navigation device 10 is manufactured or may be appropriately downloaded from the visiting-facility recommending device 30 or another server device (not illustrated) which is connected to the communication network 40 if necessary. In addition, the map information 123 may be appropriately corrected in response to, for example, an input of the user.

The communication unit 13 has, for example, a digital signal processor (DSP) and performs wireless communication with another device (for example, the visiting-facility recommending device 30) through the communication network 40 on the basis of a standard, such as 3rd Generation (3G), Long Term Evolution (LTE), or Wi-Fi (registered trademark). The communication unit 13 is used by, for example, a positional information transmitting unit 112, which will be described below, to transmit the positional information 121 and the mobile body ID 122 stored in the storage unit 12 or the information of the destination set in the route guidance unit 111 (for example, the facility ID of a facility as the destination) to the visiting-facility recommending device 30. However, the data transmitted and received between the communication unit 13 and another device is not particularly limited and information other than the positional information 121 and the mobile body ID 122 may be transmitted and received.

The sensor unit 14 includes, for example, a global positioning system (GPS) sensor, a gyro sensor, a geomagnetic sensor, and an acceleration sensor. The sensor unit 14 has a function of a position detection means for detecting positional information, receives a GPS satellite signal using the GPS sensor, and measures the positional information (latitude and longitude) of the in-vehicle navigation device 10. The sensor unit 14 performs positioning at a predetermined time interval (for example, at an interval of 3 seconds) as described above. The measured positional information is stored as the positional information 121 in the storage unit 12. The sensor unit 14 can further improve the accuracy of measuring the positional information of the in-vehicle navigation device 10 on the basis of the angular velocity or acceleration measured by the gyro sensor and the acceleration sensor. In addition, in a case in which it is difficult or impossible to perform GPS communication, the sensor unit 14 may calculate the positional information of the in-vehicle navigation device 10 on the basis of base station information acquired from the communication unit 13, using an assisted global positioning system (ALPS).

The display unit 15 is configured by a display device, such as a liquid crystal display or an organic electroluminescence panel. The display unit 15 displays an image in response to an instruction from the control unit 11. Examples of the information displayed by the display unit 15 include the current position of the in-vehicle navigation device 10, the information of a map around the current position of the in-vehicle navigation device 10 read from the map information 123, the destination set by the user, waiting information notified from other in-vehicle navigation devices 10, route information, and various user interfaces.

The input unit 16 is configured by an input device (not illustrated), such as a physical switch called a numeric keypad or a touch panel that is provided so as to be superimposed on a display surface of the display unit 15. For example, a selection operation of the user or an operation of enlarging or reducing a map can be implemented by outputting a signal based on an operation input from the input unit 16, for example, the pressing of the numeric keypad by the user or the touch of the touch panel by the user to the control unit 11.

In addition, for example, a speaker or a microphone may be provided, which is not illustrated. The speaker outputs a voice to the driver and the microphone collects, for example, a voice uttered by the driver. This configuration makes it possible to output information by voice from the speaker or to input various selections and instructions, which have been input from the driver by voice through the microphone, to the control unit 11 using voice recognition technology.

Next, the control unit 11 will be described in detail. The control unit 11 is configured by a microprocessor including, for example, a central processing unit (CPU), a random access memory (RAM), a read only memory (ROM), and an input/output (I/O). The CPU executes each program read from the ROM or the storage unit 12, and when executing the program, the CPU reads information from the RAM, the ROM, and the storage unit 12 and writes information to the RAM and the storage unit 12 to transmit and receive signals to and from the communication unit 13, the sensor unit 14, the display unit 15, and the input unit 16. In this way, hardware and software (program) cooperate with each other to implement the processes in this embodiment.

The control unit 11 includes a route guidance unit 111 and the positional information transmitting unit 112 as functional blocks. The route guidance unit 111 performs a process of performing route guidance to the destination such as the facility input or selected by the user. The process of performing route guidance to the destination is the same as a route guidance process in a general car navigation system. That is, the route guidance unit 111 can perform route guidance by generating a map to the destination on the basis of the map information 123 stored in the storage unit 12 and displaying the current position of the in-vehicle navigation device 10 measured by the sensor unit 14, the position of the destination, and route information to the destination on the display unit 15 so as to be superimposed on each other.

In this case, a voice for route guidance may be output from the speaker (not illustrated). In addition, for example, information related to the congestion state of the road or weather information may be obtained by communication using the communication unit 13 and the acquired information may be used for the route guidance process. Since the process of performing route guidance to the destination is well known to those skilled in the art, the detailed description thereof will not be repeated.

Further, the route guidance unit 111 requests the visiting-facility recommending device 30 to recommend the facility to be visited next on the basis of, for example, the operation of the user. When receiving the request, the visiting-facility recommending device 30 performs a process which will be described below to select the facility recommended to be visited next. Then, the visiting-facility recommending device 30 transmits the information of the selected facility as information of the facility recommended to be visited next to the route guidance unit 111. The route guidance unit 111 displays the information of the facility recommended to be visited next on the display unit 15 or outputs the information from the speaker (not illustrated) to notify the user of the facility recommended to be visited next. Therefore, the user can receive the recommendation of the facility to be visited next and can appropriately select the facility to be visited next, for example, even in an area other than the living area which is away from home.

In this case, the visiting-facility recommending device 30 may transmit all of the facility information to the route guidance unit 111 or may transmit a part of the facility information (for example, the facility ID) to the route guidance unit 111. In this case, the route guidance unit 111 may read the facility information corresponding to the received facility ID from the map information 123 and notify the user of the read facility information.

The positional information transmitting unit 112 is a unit that transmits the positional information 121 and the mobile body ID 122 stored in the storage unit 12 to the visiting-facility recommending device 30 through wireless communication using the communication unit 13. Further, the positional information transmitting unit 112 may transmit the information of the destination set in the route guidance unit 111 to the visiting-facility recommending device 30.

The transmission of the positional information 121 and the mobile body ID 122 to the visiting-facility recommending device 30 by the positional information transmitting unit 112 is periodically performed until the ignition switch of the vehicle 50a is turned off (the engine is stopped) after the ignition switch of the vehicle 50a is turned on (the engine is started) by the user in the vehicle 50a and then the in-vehicle navigation device 10 is automatically started. For example, the information is transmitted in real time at a predetermined time interval (for example, at an interval of 3 seconds) whenever the sensor unit 14 performs positioning. In addition, instead of transmitting the information to the visiting-facility recommending device 30 in real time, a plurality of information items (for example, the positional information 121 and the mobile body ID 122 updated at an interval of three seconds for three minutes) may be collectively transmitted once. That is, so-called burst transmission may be performed. The length of the predetermined time interval or whether to real-time transmission or to perform burst transmission can be arbitrarily set according to the environment to which this embodiment is applied.

As such, the positional information transmitting unit 112 transmits the positional information 121 for specifying the travel route of the vehicle 50a measured by the sensor unit 14 and the mobile body ID 122 to the visiting-facility recommending device 30 using the real-time transmission or the burst transmission. As described above, the positional information 121 includes not only the information indicating the measured position but also information indicating the positioning time when the positioning was performed.

Further, the positional information transmitting unit 112 can transmit, to the visiting-facility recommending device 30, the position specified by the positional information 121 measured immediately after the ignition switch is turned on (the engine is started) and then the in-vehicle navigation device 10 is automatically started as an initial vehicle position. Furthermore, the positional information transmitting unit 112 can transmit, to the visiting-facility recommending device 30, the position specified by the positional information 121 measured immediately before the ignition switch is turned off (the engine is stopped) as a final vehicle position, that is, an arrival position.

In this case, start information that indicates the positional information 121 indicating the departure position and stop information that indicates the positional information 121 indicating the arrival position are added to the positional information 121 and then the positional information is transmitted to the visiting-facility recommending device 30. For example, the positional information in which a flag indicating the start information is set to 1 may be transmitted or the positional information in which a flag indicating the stop information is set to 1 may be transmitted. The positional information 121 (that is, the arrival position) measured immediately before the ignition switch is turned off (the engine is stopped) may be transmitted when the ignition switch is turned on again (the engine is started) and then the in-vehicle navigation device 10 is started again.

Even in the burst transmission, in a case in which the route guidance unit 111 determines that the vehicle 50a has arrived at the destination (for example, a certain facility), the positional information transmitting unit 112 may be switched so as to transmit the information in real time. This configuration makes it possible to prevent the situation in which, before the positional information 121 of the arrival position is transmitted after the vehicle arrives at a certain facility, the ignition switch is turned off (the engine is stopped) and the positional information 121 of the destination, such as the facility, is not transmitted to the visiting-facility recommending device 30.

In addition to the positional information 121 and the mobile body ID 122 described above, the positional information transmitting unit 112 may transmit the information of the destination set in the route guidance unit 111 to the visiting-facility recommending device 30 through wireless communication using the communication unit 13. For example, in a case in which the user sets a destination in the route guidance unit 111, the positional information (latitude and longitude) of the destination or the facility ID of a facility corresponding to the destination is transmitted as the destination information to the visiting-facility recommending device 30. Therefore, a staying-facility estimating unit 312 of the visiting-facility recommending device 30 which will be described below can specify the facility scheduled to be visited by the vehicle 50.

### <Functional Block of Mobile Terminal 20>

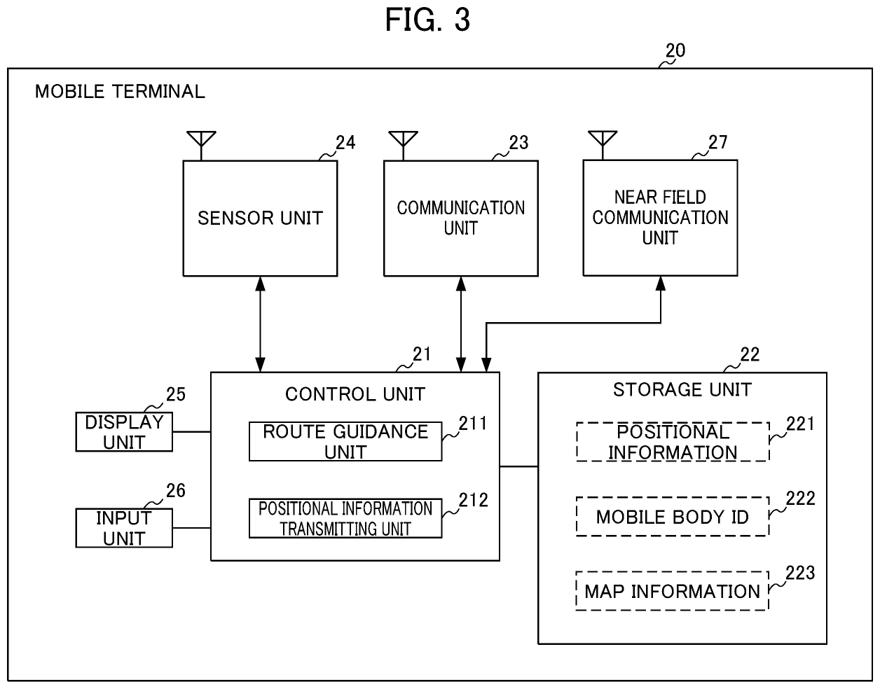

Next, the functional blocks of the mobile terminal 20 will be described with reference to a block diagram of FIG. 3. In this embodiment, the in-vehicle navigation device 10 described above is supplied with power from the vehicle 50a. However, the mobile terminal 20 is supplied with power from its own battery (not illustrated). However, the mobile terminal 20 may be configured to be supplied with power from, for example, a cigar socket of the vehicle 50b in order to charge the battery.

As illustrated in FIG. 2, the mobile terminal 20 is configured to include a control unit 21, a storage unit 22, a communication unit 23, a sensor unit 24, a display unit 25, an input unit 26, and a near field communication unit 27. Here, the control unit 21, the storage unit 22, the communication unit 23, the sensor unit 24, the display unit 25, and the input unit 26 have the same functions as the function blocks of the same names included in the in-vehicle navigation device 10 described above.

The storage unit 22 stores positional information 221, a mobile body ID 222, and map information 223. These information items are the same as those of the same names stored in the storage unit 22 of the in-vehicle navigation device 10 described above. That is, each functional block of the mobile terminal 20 is described by replacing the terms “in-vehicle navigation device 10” and “vehicle 50a” in the above description of the in-vehicle navigation device 10 with the “mobile terminal 20” and a “vehicle 50b”, respectively. Therefore, the duplicate description thereof will be omitted.

Since the mobile terminal 20 is different from the in-vehicle navigation device 10, for example, in that it includes the near field communication unit 27, the difference will be described below. The near field communication unit 27 is a unit that performs non-contact near field communication based on the Near Field Communication (NFC) standard or the Bluetooth (registered trademark) standard, or wired near field communication through, for example, a Universal Serial Bus (USB) cable.

Therefore, the vehicle 50b includes a near field communication unit for communicating with the near field communication unit 27. For example, an electronic control unit (ECU) of the vehicle 50b includes the near field communication unit. That is, the mobile terminal 20 can communicate with the

ECU using near field communication in a case in which the mobile terminal 20 is present in the vehicle 50b. In this case, positional information measured by the sensor unit 24 of the mobile terminal 20 corresponds to the positional information of the vehicle 50b. The mobile body ID 222 stored in the mobile terminal 20 corresponds to the identification information of the vehicle 50b.

Therefore, the mobile terminal 20 activates a positional information transmitting unit 212 while it can perform near field communication with the ECU through the near field communication unit 27. Then, similarly to the positional information transmitting unit 112 of the in-vehicle navigation device 10, the activated positional information transmitting unit 212 transmits the positional information 221 for specifying the travel route of the vehicle 50b measured by the sensor unit 24 and the mobile body ID 222 to the visiting-facility recommending device 30.

For example, when the user carries the mobile terminal 20, gets in the vehicle 50b, and turns on a start switch of the vehicle 50b, such as an ignition switch, the vehicle 50b and the mobile terminal 20 are connected (paired) and the positional information 221 measured by the mobile terminal 20 and the mobile body ID 222 are transmitted from the mobile terminal 20 to the visiting-facility recommending device 30. In this case, the position specified by the positional information 121 measured immediately after the pairing between the vehicle 50b and the mobile terminal 20 can be transmitted as an initial vehicle position, that is, a departure position to the visiting-facility recommending device 30.

In addition, when the start switch of the vehicle 50b, such as the ignition switch, is turned off, the pairing between the vehicle 50b and the mobile terminal 20 is released. In this case, the position specified by the positional information 121 measured immediately before the release can be transmitted as a final vehicle position, that is, an arrival position to the visiting-facility recommending device 30. In this case, the positional information transmitting unit 112 is the same as the positional information 221 includes information indicating the positioning time when the positioning was performed; real-time transmission or burst transmission may be performed; in a case in which it is determined that the vehicle has arrived at the arrival position, the transmission may be switched from the burst transmission to the real-time transmission; start information or stop information indicating the start position or the arrival position may be added; the arrival position may be transmitted when the vehicle is started again; or destination information may also be transmitted.

In a case in which the vehicle 50b has a function of measuring positional information, not positional information measured by the sensor unit 24 but positional information measured by the vehicle 50b may be transmitted as the positional information 221 to the visiting-facility recommending device 30. In this case, the sensor unit 24 may be omitted from the mobile terminal 20.

### <Functional Blocks of Visiting-Facility Recommending Device 30>

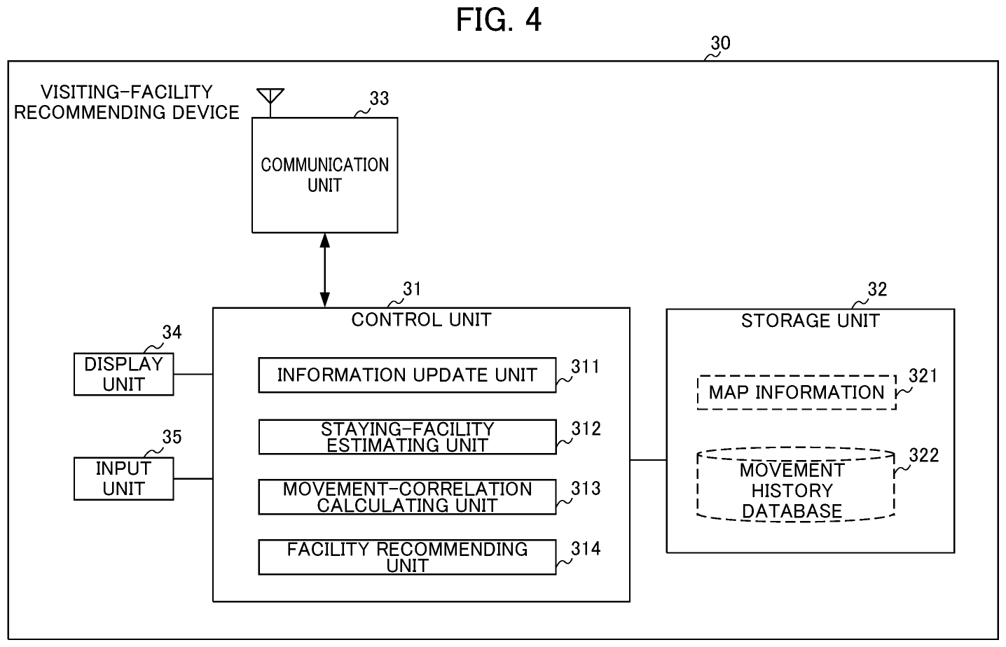

Next, the functional blocks of the visiting-facility recommending device 30 will be described with reference to a block diagram of FIG. 4.

As illustrated in FIG. 4, the visiting-facility recommending device 30 is configured to include a control unit 31, a storage unit 32, a communication unit 33, a display unit 34, and an input unit 35.

The control unit 31 is configured by an arithmetic processing device, such as a microprocessor, and controls each unit of the visiting-facility recommending device 30. The control unit 31 will be described in detail below.

The storage unit 32 is configured by, for example, a semiconductor memory and stores various programs including a control program which is called firmware or an operating system and a program for performing a process of recommending the facility to be visited and various kinds of information including map information. In the drawings, map information 321 and movement history database 322 which are information particularly related to a positional information analysis process are illustrated as the information stored in the storage unit 32.

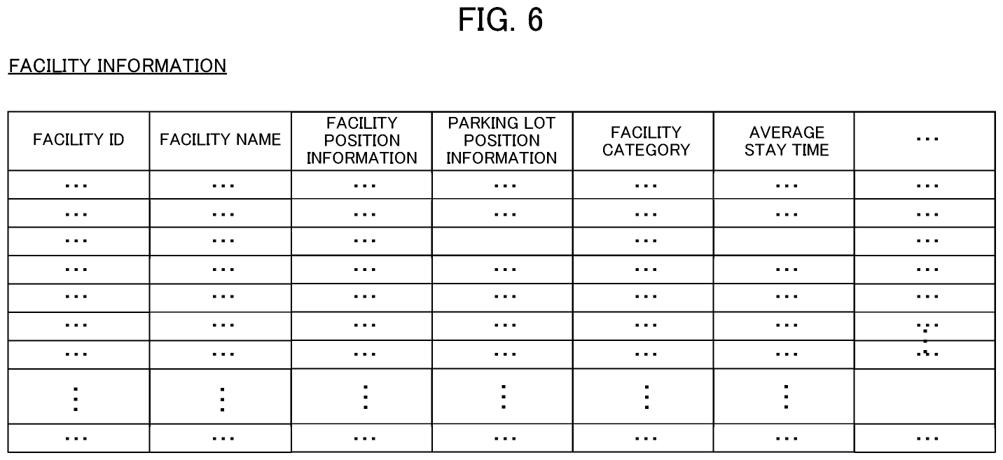

The map information 321 is basically the same information as the map information 123 and the map information 223 which have been described above. However, the map information 321 includes more detailed facility information than the map information 123 and the map information 223 in order to recommend facilities. The map information 321 may be configured to be stored in advance similarly to the map information 123 or the map information 223 or may be configured to be appropriately downloaded from the server device (not illustrated) that is connected to the communication network 40 if necessary. Further, the map information 321 may be appropriately corrected in response to, for example, an input of the user. Furthermore, for example, an information update unit 311 which will be described below may update information, such as an “average stay time”, in the facility information included in the map information 321. The facility information included in the map information 321 will be described below with reference to FIG. 6.

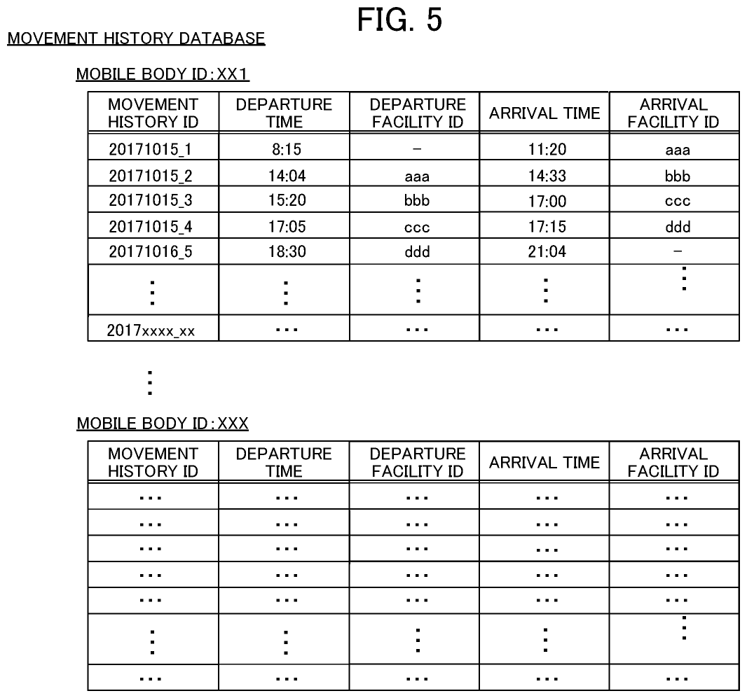

The movement history database 322 is a database that is constructed on the basis of the positional information 121 and the mobile body ID 122 received from the in-vehicle navigation device 10 and the positional information 221 and the mobile body ID 222 received from the mobile terminal 20. The movement history database 322 is constructed by the information update unit 311 which will be described below. The movement history database 322 will be described in detail below with reference to FIG. 5 when the information update unit 311 is described. In the following description, when the positional information 121 and the positional information 221 are described without distinction, the reference numerals are omitted and the positional information 121 and the positional information 221 are referred to as “positional information”. Similarly, when the mobile body ID 122 and the mobile body ID 222 are described without distinction, the reference numerals are omitted and the mobile body ID 122 and the mobile body ID 222 are referred to as “mobile body IDs”.

The communication unit 33 has, for example, a digital signal processor (DSP) and performs wireless communication with another device through the communication network 40 through the communication network 40 on the basis of a standard, such as 3rd Generation (3G), Long Term Evolution (LTE), or Wi-Fi (registered trademark). The communication unit 33 is used to receive information, such as the positional information and the mobile body ID, transmitted from each of the in-vehicle navigation device 10 and the mobile terminal 20. In addition, for example, the communication unit 33 is used to transmit map information to the in-vehicle navigation device 10 and the mobile terminal 20. However, the data transmitted and received between the communication unit 33 and another device is not particularly limited and information other than the above-mentioned information may be transmitted and received.

The display unit 34 is configured by a display device such as a liquid crystal display or an organic electroluminescence panel. The display unit 15 displays an image in response to an instruction from the control unit 11. Examples of the information displayed by the display unit 15 include map information read from the map information 321, each information item in the movement history database read from the movement history database 322, and various user interfaces.

The input unit 35 is configured by an input device (not illustrated), such as a keyboard or a mouse. For example, a process, such as the correction of the map information 321 or the movement history database 322 or the selection of the in-vehicle navigation device 10 or the mobile terminal 20 as the transmission destination of the information of the facility recommended to be visited, can be performed on the basis of an operation input from the input unit 16. These operations are performed by, for example, a business operator that manages the visiting-facility recommending device 30.

Next, the control unit 31 will be described in detail. The control unit 31 is configured by a microprocessor including, for example, a central processing unit (CPU), a random access memory (RAM), a read only memory (ROM), and an input/output (I/O).

The CPU executes each program read from the ROM or the storage unit 32. When executing the program, the CPU reads information from the RAM, the ROM, and the storage unit 32 and writes information to the RAM and the storage unit 32 to transmit and receive signals to and from the communication unit 33, the display unit 34, and the input unit 35. In this way, hardware and software (program) cooperate with each other to implement the processes in this embodiment.

The control unit 31 includes, as functional blocks, the information update unit 311, the staying-facility estimating unit 312, a movement-correlation calculating unit 313, and a facility recommending unit 314. The information update unit 311 is a unit that constructs the movement history database 322 and appropriately updates the movement history database 322. An example of the data structure of the movement history database 322 will be described with reference to FIG. 5.

As illustrated in FIG. 5, information items, such as a movement history ID, a departure time, a departure facility ID, an arrival time, and an arrival facility ID, are stored in the movement history database 322 so as to be associated with each other. These information items are stored for each drive in the information update unit 311 so as to be associated with each other. That is, information items based on the mobile body ID or the positional information received until the ignition switch is turned off (the engine is stopped) and the transmission of the positional information ends after the ignition switch of the vehicle 50 is turned on (the engine is started) and the transmission of the positional information starts are stored as one unit so as to be associated with each other. Further, the information update unit 311 stores information of a new drive in chronological order whenever the new drive is performed. As such, the movement history database 322 is constructed as a database indicating the excursion behavior of the user of the vehicle 50. In addition, the information update unit 311 creates the database for each mobile body. That is, the information update unit 311 creates the database for each “mobile body ID” for identifying the in-vehicle navigation device 10 or the mobile terminal 20 which is the transmission source of the positional information.

Here, the “movement history ID” in the movement history database 322 is identification information for identifying each movement history. As described above, the information update unit 311 stores the information items for each drive so as to be associated with each drive.

The “departure time” in the movement history database 322 is the time when the ignition switch of the vehicle 50 is turned on (the engine is started) and the transmission of the positional information is started. The departure time is specified on the basis of the time information included in the positional information and the start information which indicates that the ignition switch has been turned on and is included in the positional information.

The “departure facility ID” in the movement history database 322 is the ID of the facility corresponding to the positional information (that is, the positional information is transmitted first in the drive) at the departure time when the ignition switch of the vehicle 50 is turned on (the engine is started) and the transmission of the positional information is started. The information update unit 311 can compare the positional information at the departure time when the transmission of the positional information is started with the facility information included in the map information 321 to specify the departure facility ID.

In a case in which the departure position is a place to which a facility ID is not assigned, such as a private parking lot, the facility ID is not specified even though the positional information at the departure time is compared with the facility information. In this case, for example, the information update unit 311 stores information indicating that it is difficult to specify the departure facility ID such that “—” is described in a departure facility ID corresponding to a movement history ID “20171015_1” in FIG. 5.

The “arrival time” in the movement history database 322 is the time when the ignition switch of the vehicle 50 is turned off (the engine is stopped) and the transmission of the positional information ends. The arrival time is specified on the basis of the time information included in the positional information and the stop information which indicates that the ignition switch has been turned off and is included in the positional information.

The “arrival facility ID” in the movement history database 322 is the ID of the facility corresponding to the positional information (that is, the positional information is transmitted last in the drive) at the arrival time when the ignition switch of the vehicle 50 is turned off (the engine is stopped) and the transmission of the positional information ends. The information update unit 311 can compare the positional information at the arrival time when the transmission of the positional information ends with the facility information included in the map information 321 to specify the arrival facility ID, similarly to the departure facility ID. In a case in which the arrival position is a place to which a facility ID is not assigned, such as a private parking lot, the information update unit 311 stores information indicating that it is difficult to specify the arrival facility ID, similarly to the departure facility ID.

Information other than the information illustrated in FIG. 5 may be further included in the movement history database 322. For example, all of the positional information received for the period from the start to the end of the transmission of the positional information may be included. The positional information is information indicating the travel route of the vehicle 50 that changes in a time-discrete manner with the movement of the vehicle 50 and can be used, for example, to specify or analyze the travel route actually used between the facilities.

Whenever the transmission of the positional information and the mobile body ID from any of the in-vehicle navigation devices 10 and the mobile terminal 20 is started and ended, the information update unit 311 stores each of the above-mentioned information items in a new field on the basis of the received positional information and mobile body ID to update the movement history database 322.

Next, the staying-facility estimating unit 312 will be described. The staying-facility estimating unit 312 estimates a staying facility of the in-vehicle navigation device 10 or the mobile terminal 20 (hereinafter, referred to as a “target mobile body”) which is a notification destination of the facility recommended to be visited. Here, the in-vehicle navigation device 10 or the mobile terminal 20 that has transmitted a request for the facility recommended to be visited to the visiting-facility recommending device 30 is the target mobile body. For example, when the route guidance unit 111 of the in-vehicle navigation device 10 provided in a certain vehicle 50 is the transmission source of the request for the facility recommended to be visited, the in-vehicle navigation device 10 provided in the certain vehicle 50 is the target mobile body.

As a method for estimating the staying facility of the target mobile body, for example, three methods are considered. First, as a first method, a method is considered which estimating a facility in which the target mobile body is currently staying on the basis of positional information received from the target mobile body. In the case of this method, the staying-facility estimating unit 312 compares the positional information indicating the current position received from the target mobile body with the facility information included in the map information 321 to estimate the facility in which the target mobile body is currently staying as the staying facility.

As a second method, a method is considered which estimates a facility in which the target mobile body stays last on the basis of the positional information received from the target mobile body. In the case of this method, the staying-facility estimating unit 312 compares the positional information indicating the current position received from the target mobile body with the facility information included in the map information 321 to estimate the facility in which the target mobile body has stayed last as the staying facility. In a case in which the staying facility is estimated by these methods, for example, the staying-facility estimating unit 312 may perform the estimation in consideration of the positional information indicating the current position received in the past with reference to the movement history database 322.

As a third method, in a case in which the information of the destination in route guidance is received from the target mobile body, it is possible to estimate, as the staying facility, the facility which is the current destination of the target mobile body on the basis of the information of the destination. For example, in a case in which the facility ID of the facility which is the destination is received as the information of the destination from the target mobile body, it is possible to estimate, as the staying facility, the facility which is the current destination of the target mobile body on the basis of the facility ID. The staying-facility estimating unit 312 also outputs the estimated staying facility to the movement-correlation calculating unit 313.

The movement-correlation calculating unit 313 calculates a movement correlation between the staying facility estimated by the staying-facility estimating unit 312 and each of the other facilities. The staying-facility estimating unit 312 calculates the movement correlation on the basis of the movement history stored in the movement history database 322. An example of a method for calculating the movement correlation will be described on the basis of the movement history of a “mobile body ID: XX1” illustrated in FIG. 5.

Referring to this movement history, the mobile body with the “mobile body ID: XX1” departs from an unknown facility (for example, a private parking lot), is moved in the order of a facility with a “facility ID: aaa”, a facility with a “facility ID: bbb”, a facility with a “facility ID: ccc”, and a facility with a “facility ID: ddd”, and arrives at an unknown facility (for example, a private parking lot). Therefore, for example, the staying-facility estimating unit 312 can calculate that a facility having a high movement correlation with the facility with the “facility ID: aaa” is the facility with “facility ID: bbb” to which the user has moved next. Similarly, for example, the staying-facility estimating unit 312 can calculate that a facility having a high movement correlation with the facility with the “facility ID: bbb” is the visiting facility with “facility ID: ccc” to which the user has moved next.

The staying-facility estimating unit 312 calculates the movement correlation for each movement history of each mobile body in this way and adds the calculated movement correlations to specify a facility with a high movement correlation with each facility.

However, in some cases, when all the movement histories are used, it is difficult to appropriately calculate the movement correlation. For example, in some cases, from the viewpoint of recommending the facility to be visited, a convenience store or a gas station at which the user stops off on the way to a target facility may not be used for calculating the movement correlation. The reason is that, in general, the convenience store, the gas station, or the like is a facility at which the user stops off for simple shopping or refueling and is not recommended for leisure purposes such as sightseeing and travel.

Therefore, the staying-facility estimating unit 312 calculates, for example, the difference between the arrival time at a certain facility and the departure time from the certain facility as the stay time at the certain facility. In a case in which the stay time is short (for example, the stay time is 20 minutes or less), the certain facility is determined to be a convenience store or a gas station at which the user stops off on the way to the target facility and may not be used for calculating the movement correlation.

For example, the difference between the arrival time at the facility with the “facility ID: ccc” in a “move history ID 20171015_4” and the departure time from the facility with the “facility ID: ccc” in a “move history ID 20171015_5” is only 5 minutes. Therefore, the user stays at the facility with the “facility ID: ccc” for only 5 minutes and just stays off at the facility and the facility is not used for calculating the movement correlation. As a result, it can be calculated that a facility having a high movement correlation with the facility with the facility ID: bbb is not the facility with the “facility ID: ccc” and is the facility with the “facility ID: ddd”. As such, whether or not there is a convenience store or a gas station at which the user stops off may not be determined on the basis of the stay time, but may be determined on the basis of the facility information included in the map information 321. Then, the facility that has been determined to be the place at which the user stops off on the basis of the facility information may not be used for calculating the movement correlation.

The movement-correlation calculating unit 313 calculates the movement correlation in this way and outputs a value indicating the level of the movement correlation between the staying facility estimated by the staying-facility estimating unit 312 and each of the other facilities to the facility recommending unit 314.

In the above-mentioned example, in a case in which the user has moved in the order of a facility A, a facility B, a facility C, and a facility D, the facility having a high movement correlation with the facility B is calculated as the facility C that is the facility to which the user has moved next. As a modification example, the facility having a high movement correlation with the facility B may be calculated as the facility A which is the previous movement source. Further, the facilities having a high movement correlation with the facility B may be calculated as both the facility A and the facility C. In this case, for example, weighting may be performed such that the facility B has the highest movement correlation with the facility C, has the second highest movement correlation with the facility A, and has the third highest movement correlation with the facility D.

The facility recommending unit 314 selects a facility recommended to be visited next on the basis of the value which indicates the level of the movement correlation between the staying-facility estimated by the staying-facility estimating unit 312 and each of the other facilities and has been input from the movement-correlation calculating unit 313. For example, the facility recommending unit 314 selects a facility having the highest movement correlation with the staying facility estimated by the staying-facility estimating unit 312. Then, the facility recommending unit 314 acquires the detailed information of the selected recommended facility from the facility information included in the map information 321.

An example of the facility information included in the map information 321 will be described with reference to FIG. 6. As illustrated in FIG. 6, the facility information includes a facility ID, a facility name, facility position information, parking lot position information, a facility category, and an average stay time.

The “facility ID” included in the facility information is identification information for identifying each facility. The “facility name” included in the facility information is the name of each facility. For example, in a case in which the facility is a store, the facility name is the name of the store.

In addition, the “facility position information” included in the facility information is positional information (for example, latitude and longitude) indicating the position where the facility is present. Further, the “parking lot position information” included in the facility information is positional information (for example, latitude and longitude) indicating the position of a parking lot attached to the facility.

Furthermore, the “facility category” included in the facility information is information indicating the type of facility. For example, the “facility category” is information such as “a museum”, a “movie theater”, a “restaurant”, or a “hot spring facility”. In addition, the “average stay time” included in the facility information is the average value of the time for which the user stayed at each facility. The average stay time is appropriately updated when the information update unit 311 updates the movement history database 322. When updating the movement history database 322, the information update unit 311 calculates the difference between the arrival time at a certain facility and the departure time from the certain facility as the stay time at the certain facility with reference to the movement history. Then, the information update unit 311 averages the time calculated so far as the stay time at the certain facility to appropriately update the “average stay time” included in the facility information.

These information items are only some of the information items that can be included in the facility information. In addition, for example, the information of coupons issued by the facility or accessory information, such as the business hours and phone number of the facility, may be further included in the facility information.

The facility recommending unit 314 acquires information included in the facility information as the detailed information of the recommended facility and transmits the acquired information of the recommended facility to the target mobile body, thereby notifying facility recommendation information. However, in a case in which not one facility but a plurality of facilities (for example, three facilities) are recommended as the visiting facility, the facility information of each of a plurality of facilities (for example, three facilities from the top) from the top in descending order of the movement correlation is transmitted to the target mobile body together with the rank of the movement correlation to notify the facility recommendation information.

The target mobile body notifies the user of the facility recommendation information by displaying the notified facility recommendation information on the display unit 15 or the display unit 25 included in the target mobile body. Therefore, the user can receive a recommendation of the facility to be visited next and can appropriately select the facility to be visited next, for example, even in an area other than the living area away from home.

<Operation of this Embodiment>

Next, the detailed process of this embodiment will be described with reference to a flowchart of FIG. 11. In Step S11, the information update unit 311 determines whether the communication unit 33 has received information, such as positional information and a mobile body ID, from any of the in-vehicle navigation devices 10 and the mobile terminal 20. In a case in which the information, such as the positional information and the mobile body ID, has been received from any of the in-vehicle navigation devices 10 and the mobile terminal 20, the determination result in Step S11 is “Yes” and the process proceeds to Step S12. On the other hand, in a case in which the information, such as the positional information and the mobile body ID, has not been received from any of the in-vehicle navigation devices 10 and the mobile terminal 20, the determination result in Step S11 is “No” and the process proceeds to Step S13.

In Step S12, the information update unit 311 updates the movement history database 322 on the basis of, for example, the positional information received in Step S12. In addition, the information update unit 311 appropriately updates the “average stay time” of the facility information included in the map information 321 on the basis of, for example, the positional information received in Step S12.

In Step S13, the staying-facility estimating unit 312 determines whether a request to recommend a facility to be visited has been received from any of the in-vehicle navigation devices 10 and the mobile terminal 20. In a case in which the request to recommend the facility to be visited has been received from any of the in-vehicle navigation devices 10 and the mobile terminal 20, the determination result in Step S13 is “Yes” and the process proceeds to Step S14. On the other hand, in a case in which the request to recommend the facility to be visited has not been received from any of the in-vehicle navigation devices 10 and the mobile terminal 20, the determination result in Step S13 is “No” and the process returns to Step S11. Then, the above-mentioned process is repeated.

In Step S14, the staying-facility estimating unit 312 estimates the staying facility of the target mobile body which is the transmission source of the request to recommend the facility to be visited. In addition, the staying-facility estimating unit 312 outputs the estimated staying facility to the movement-correlation calculating unit 313.

In Step S15, the movement-correlation calculating unit 313 calculates the movement correlation between the staying facility input in Step S14 and each of the other facilities. Further, the movement-correlation calculating unit 313 outputs the calculated movement correlation to the facility recommending unit 314.

In Step S16, the facility recommending unit 314 selects a facility recommended as the visiting facility on the basis of the movement correlation input in Step S13. In addition, the facility recommending unit 314 acquires the detailed information of the selected recommended facility from the facility information included in the map information 321.

In Step S17, the facility recommending unit 314 notifies the target mobile body of the detailed information of the recommended facility acquired in Step S16 as the facility recommendation information, using the communication unit 33. Then, the target mobile body notifies the user of facility recommendation information, for example, by displaying the notified facility recommendation information on the display unit 15 or the display unit 25 included in the target mobile body. Then, the process ends.

The above-mentioned process enables the user to receive a recommendation of the facility to be visited next. For example, the above-mentioned process enables the user to appropriately select the facility to be visited next even in an area other than the living area which is away from home. Further, in the above-mentioned process, it is not necessary to acquire information, such as images, from each facility. Therefore, it is possible to recommend the facility to be visited without installing dedicated equipment in each facility.

### <For Hardware and Software>

Each of the devices included in the above-mentioned visiting-facility recommending system can be implemented by hardware, software, or a combination thereof. In addition, a visiting-facility recommending method performed by the cooperation of each of the devices included in the above-mentioned visiting-facility recommending system can be implemented by hardware, software, or a combination thereof. Here, the implementation by software means implementation by the reading and execution of a program by a computer.

The program may be stored using various types of non-transitory computer readable media and supplied to the computer. The non-transitory computer readable media include various types of tangible storage media. Examples of the non-transitory computer readable medium include a magnetic recording medium (for example, a flexible disk, a magnetic tape, or a hard disk drive), a magneto-optical recording medium (for example, a magneto-optical disk), a compact disc read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). In addition, the program may be supplied to the computer by various types of transitory computer readable media. Examples of the transitory computer readable medium include electrical signals, optical signals, and electromagnetic waves. The transitory computer readable medium can provide the program to the computer through a wired communication line, such as an electric wire and an optical fiber, or a wireless communication line.

### MODIFICATION EXAMPLES

The above-described embodiment is a preferred embodiment of the invention. However, the scope of the invention is not limited only to the above-described embodiment and can include various modification examples without departing from the scope and spirit of the invention.

### First Modification Example

In the above-described embodiment, the facility recommending unit 314 selects a facility recommended as the facility to be visited next on the basis of only the movement correlation calculated by the movement-correlation calculating unit 313. However, the invention is not limited thereto and a recommended facility may be selected in consideration of other information. For example, a traffic information acquisition unit that acquires traffic information, such as traffic congestion information, on the basis of a Vehicle Information and Communication System (VICS) standard or the like may be further added to the visiting-facility recommending device 30. Then, the facility recommending unit 314 may select a recommended facility in consideration of the traffic information acquired by the traffic information acquisition unit. For example, in a case in which a facility has the highest movement correlation and a route to the facility is congested, the facility recommending unit 314 may select a facility with the second highest movement correlation as the recommended facility. This configuration makes it possible to prevent the visiting facility to which the route is congested from being recommended. In addition, the users who visit again are concentrated. It is possible to prevent the facility from being crowded.

### Second Modification Example

In addition, the facility recommending unit 314 may select a recommended facility in consideration of other information. For example, the user who has visited a hot spring facility is less likely to visit another hot spring facility next and the user who has visited a movie theater is less likely to visit another movie theater next. Therefore, for example, the facility recommending unit 314 may select a recommended facility on the basis of the “facility category” of the facility information included in the map information 321 such that the facilities in the same facility category are not consecutive. For example, in a case in which the current staying facility is a restaurant and the facility category of a facility having the highest movement correlation is a restaurant, a facility in a category other than the restaurant which has the second highest movement correlation may be selected as the recommended facility.

### Third Modification Example

Further, the facility recommending unit 314 may select a recommended facility in consideration of other information. For example, the facility found to have been visited on the same day or a near day on the basis of the movement history of the movement history database 322 may not be recommended even in a case in which the movement correlation of the facility with the current staying facility is high. This configuration makes it possible to prevent the same facility from being recommended many times in a short time.

### Fourth Modification Example

In addition, the facility recommending unit 314 may include information other than the information exemplified in the above-described embodiment in the facility recommendation information to be notified to the target mobile body. For example, the facility recommending unit 314 calculates the time required to move between the facilities in each movement history with reference to the movement history database 322. Then, the facility recommending unit 314 further calculates the average of the calculated time required for movement and estimates a necessary movement time for movement between the facilities. For example, the facility recommending unit 314 calculates the time required to move between a first facility and a second facility in each movement history. Then, the facility recommending unit 314 further calculates the average of the calculated time required for movement to further estimate the necessary movement time for movement between the first facility and the second facility.

Further, the facility recommending unit 314 calculates the expected exit time in a case in which the user visits the recommended facility on the basis of the time required for movement and the average stay time (that is, the length of time that is a rough standard of the length of the stay time) in the facility information included in the map information 321. For example, in a case in which the target mobile body is staying at the first facility and the second facility is recommended, the facility recommending unit 314 adds the movement time required for the movement between the first facility and the second facility and the average stay time at the second facility to the current time to calculate the expected exit time.

Then, the facility recommending unit 314 includes the calculated expected exit time in the facility recommendation information to be notified to the target mobile body. In a case in which the user who has referred to the expected exit time can visit the recommended facility and exit the facility earlier than expected, the user may decide to visit the recommended facility.

In addition, in a case in which the user exits the facility later than expected, the user can determine to visit the recommended facility at a later date.

### Fifth Modification Example

In the above-described embodiment, the movement-correlation calculating unit 313 calculates the movement correlation on the basis of all the movement histories included in the movement history database 322. The invention is not limited thereto and the movement-correlation calculating unit 313 may calculate the movement correlation on the basis of some of the movement histories. For example, the movement correlation may be calculated on the basis of only the movement history in the same time period as the time period for which the movement correlation is calculated (that is, the time period for which the facility is recommended). In this case, it is possible to recommend the facility to be visited next by each user in the time period. Therefore, for example, in a case in which recommendation is performed at night, it is possible to prevent a facility to be visited during the day, such as a zoo, from being recommended. From a similar viewpoint, the movement correlation may be calculated on the basis of only the movement histories related to the same day of the week or the same season, instead of the time period. In this case, for example, it is possible to prevent a facility, such as a ski resort, from being recommended in a season other than the ski season.

### Other Modification Examples

The functional configurations illustrated in FIGS. 2, 3, and 4 are merely examples and the functional configurations of this embodiment are not limited thereto. That is, each device may have a function capable of performing a series of processes related to the information analysis function of the invention as a whole and what kind of functional block is used to achieve this function is not particularly limited to the examples illustrated in FIGS. 2, 3, 3, and 4.

Further, as still another modification example, the in-vehicle navigation device 10 or the mobile terminal 20 may be achieved by another device without having a route guidance function. That is, the route guidance function of the in-vehicle navigation device 10 or the mobile terminal 20 is not an essential component. In this case, the visiting-facility recommending device 30 may further have the route guidance function. The visiting-facility recommending device 30 may communicate with the in-vehicle navigation device 10 or the mobile terminal 20 to perform route guidance.

In the above-described embodiment, the visiting-facility recommending device 30 is achieved by, for example, one server device. However, as yet another modification example, a distributed processing system in which each function of the visiting-facility recommending device 30 is appropriately distributed to a plurality of server devices may be used. Further, each function of the visiting-facility recommending device 30 may be implemented by using, for example, a virtual server function on the cloud.

### EXPLANATION OF REFERENCE NUMERALS

1 VISITING-FACILITY RECOMMENDING SYSTEM
10 IN-VEHICLE NAVIGATION DEVICE
11, 21, 31 CONTROL UNIT
111, 211 ROUTE GUIDANCE UNIT
112, 212 POSITIONAL INFORMATION TRANSMITTING UNIT
12, 22, 32 STORAGE UNIT
121, 221 POSITIONAL INFORMATION
122, 222 MOBILE BODY ID
123, 223 MAP INFORMATION
13, 23, 33 COMMUNICATION UNIT
14, 24 SENSOR UNIT
15, 25 DISPLAY UNIT
16, 26 INPUT UNIT
20 MOBILE TERMINAL
27 NEAR FIELD COMMUNICATION UNIT
30 VISITING-FACILITY RECOMMENDING DEVICE
311 INFORMATION UPDATE UNIT
312 STAYING-FACILITY ESTIMATING UNIT
313 MOVEMENT-CORRELATION CALCULATING UNIT
314 FACILITY RECOMMENDING UNIT
321 MAP INFORMATION
322 MOVEMENT HISTORY DATABASE
40 COMMUNICATION NETWORK
50a, 50b VEHICLE

1. A visiting-facility recommending device comprising:
a receiving unit that receives current positions of a plurality of mobile bodies;
a map unit that stores road map information and information of a plurality of facilities;
a staying-facility estimating unit that estimates a staying facility at which a target mobile body which is a mobile body as an estimation target is staying;
a movement-correlation calculating unit that calculates a movement correlation between the facilities from a past movement history of the plurality of mobile bodies between the plurality of facilities; and
a facility recommending unit that selects a facility recommended to be visited next on the basis of the estimated staying facility and the calculated movement correlation between the facilities.

2. The visiting-facility recommending device according to claim 1,
wherein the staying-facility estimating unit estimates a facility at which the target mobile body is currently staying or a facility at which the target mobile body has stayed last as the staying facility on the basis of a current position of the target mobile body.

3. The visiting-facility recommending device according to claim 1,
wherein the receiving unit further receives information of a destination of the target mobile body, and
the staying-facility estimating unit estimates a facility that is the destination of the target mobile body as the staying facility on the basis of the received information of the destination of the target mobile body.

4. The visiting-facility recommending device according to claim 1, further comprising:
a traffic information acquisition unit that acquires current or future traffic information,
wherein the facility recommending unit selects the facility recommended to be visited next in consideration of the current or future traffic information.

5. The visiting-facility recommending device according to claim 1,
wherein the map unit further stores facility type information in the information of the plurality of facilities, and
the facility recommending unit accumulates a history of the staying facility and selects the facility recommended to be visited next, further considering type information of the history of the staying facility.

6. The visiting-facility recommending device according to claim 1,
wherein the map unit further stores information of an estimated stay time at a facility in the information of the plurality of facilities, and
the facility recommending unit calculates an expected exit time from the facility recommended to be visited next, on the basis of the estimated stay time at the selected facility recommended to be visited next and a movement time between the facilities estimated from the past movement history of the plurality of mobile bodies between the plurality of facilities.

7. A visiting-facility recommending method performed by a computer, the method comprising:
a receiving step of receiving current positions of a plurality of mobile bodies;
a map step of storing road map information and information of a plurality of facilities in a map unit;
a staying-facility estimating step of estimating a staying facility at which a target mobile body which is a mobile body as an estimation target is staying;
an inter-facility movement correlation calculation step of calculating a movement correlation between the facilities from a past movement history of the plurality of mobile bodies between the plurality of facilities; and
a facility recommending step of selecting a facility recommended to be visited next on the basis of the estimated staying facility and the calculated movement correlation between the facilities.
